(19) United States
(12) Patent Application Publication
(10) Pub. No.: US 2007/0101353 A1
(43) Pub. Date: May 3, 2007

(54) Apparatus and method for blocking harmful multimedia contents in personal computer through intelligent screen monitoring

(76) Inventors: Chi Yoon Jeong, Gyeongsangnam-do (KR); Seung Wan Han, Gwangjoo-city (KR); Su Gil Choi, Busan-city (KR); Taek Yong Nam, Daejeon-city (KR); Jong Soo Jang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/443,660

(22) Filed: May 31, 2006

(30) Foreign Application Priority Data
Oct. 27, 2005 (KR) 10-2005-0101741

(51) Int. Cl. H04H 9/00

(52) U.S. Cl. 725/13

(57) ABSTRACT

An apparatus and method for blocking harmful multimedia contents in a personal computer using intelligent screen monitoring are provided. The apparatus includes a screen capture determination unit determining a screen capture time based on the status of a personal computer; an active screen capture unit capturing a screen displaying an active program at the screen capture time; an image harmfulness determination unit determining the harmfulness of the captured screen; and a harmful program blocking unit blocking the program displayed on the captured screen, if the screen is determined to be harmful. The method and apparatus can be used to block access to harmful multimedia contents in real time using a screen capture method in which a screen of the personal computer is captured intelligently, harmfulness of the captured screen is determined, and a corresponding program using the captured screen is blocked.

### CROSS-REFERENCE TO RELATED PATENT APPLICATION

This application claims the benefit of Korean Patent Application No. 10-2005-0101741, filed on Oct. 27, 2005, in the Korean Intellectual Property Office, the disclosure of which is incorporated herein in its entirety by reference.

### BACKGROUND OF THE INVENTION

1. Field of the Invention

The present invention relates to an apparatus and method for blocking harmful multimedia contents using intelligent screen monitoring in a personal computer (PC), and more particularly, to an apparatus and a method for monitoring the status of a PC including the status of a central processing unit, a memory, a storage device, and an input device, determining a PC screen capture time intelligently, determining the harmfulness of a captured screen, and blocking harmful multimedia contents in real time.

2. Description of Related Art

Recently, it has become possible to transfer a large volume of multimedia contents quickly using file transfer protocol or Peer to Peer file sharing due to rapid development of network infra-structure. However, harmful multimedia contents constitute a considerable part of large volume contents, and the development of the network infra-structure has resulted in the fast distribution of harmful multimedia contents. A method and apparatus for blocking harmful multimedia contents are required because harmful multimedia contents may adversely affect minors.

One conventional technique for blocking harmful multimedia contents is a method of analyzing data transferred via networks in connection with a software program such as a mail client, a web browser, or the like to block harmful contents. In another method, a screen of a PC is captured and stored at a time predetermined by a supervisor, and the stored screen is inspected by the supervisor.

The method of analyzing transferred data via networks in connection with a software program such as a mail client, a web browser, or the like to block harmful contents cannot be used to block harmful moving pictures, which constitute the largest part of harmful multimedia contents, and is dependent on a specific program. In addition, since the data transferred via networks should be analyzed, the use of the method reduces network speed, and a software program implementing the method may interfere with other programs installed in the PC, thereby destabilizing the PC.

The method in which a screen of the PC is captured and stored at a time predetermined by a supervisor to be inspected later by the supervisor has a disadvantage of failing to block harmful multimedia contents in real time. In addition, storage space is wasted as a result of unnecessary screen captures caused by capturing the screen of the PC at regular intervals, even when the PC is in an idle, and the blocking can be easily avoided by a user, who can display harmless contents on the screen at the screen capture time if the interval of the screen capture is known to the user.

### SUMMARY OF THE INVENTION

The present invention provides an apparatus and method for blocking harmful multimedia contents in a personal computer and a computer readable recording medium on which computer code implementing the method is recorded. In the apparatus and method, the status of the personal computer including a status of a central processing unit, a memory, a storage device, an input device of the personal computer is monitored, a time when it is unclear whether a user uses a program accessing harmful multimedia contents is intelligently determined, a screen of the personal computer is captured at the determined time, the harmfulness of the captured screen is determined using harmful image classification technology and text information extraction technology, and a program currently displayed on the screen is blocked to prevent the user from accessing harmful multimedia contents in real time, if the captured screen is determined harmful.

According to an aspect of the invention, there is provided a harmful multimedia contents blocking apparatus using intelligent screen monitoring comprising: a screen capture determination unit determining a screen capture time based on a status of a personal computer; an active screen capture unit capturing a screen of an active program at the determined time; an image harmfulness determination unit determining harmfulness of the captured screen; and a harmful program blocking unit blocking the application program using the captured screen, if the screen is determined harmful.

According to another aspect of the invention, there is provided a harmful multimedia contents blocking method using intelligent screen monitoring, the method comprising: determining a screen capture time while monitoring a status of a personal computer; capturing a window of a currently active application program at the determined time; determining harmfulness of the captured screen; and blocking the application program using the screen and storing related records, if the screen is determined harmful.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for blocking harmful multimedia contents using intelligent screen monitoring according to an embodiment of the present invention;

FIG. 2 is a block diagram of a screen capture determination unit illustrated in FIG. 1;

FIG. 3 is a detailed block diagram of the screen capture determination unit illustrated in FIG. 2;

FIG. 4 is a block diagram of the apparatus for blocking harmful multimedia contents using intelligent screen monitoring illustrated in FIG. 1 with a image harmfulness determination unit illustrated in detail; and

FIG. 5 is a flowchart of a method of blocking harmful multimedia contents using intelligent screen monitoring in a PC according to an embodiment of the present invention.

### DETAILED DESCRIPTION OF THE INVENTION

Hereinafter, the present invention will be described in detail by explaining exemplary embodiments of the invention with reference to the attached drawings. Like reference numerals denote like elements throughout the drawings.

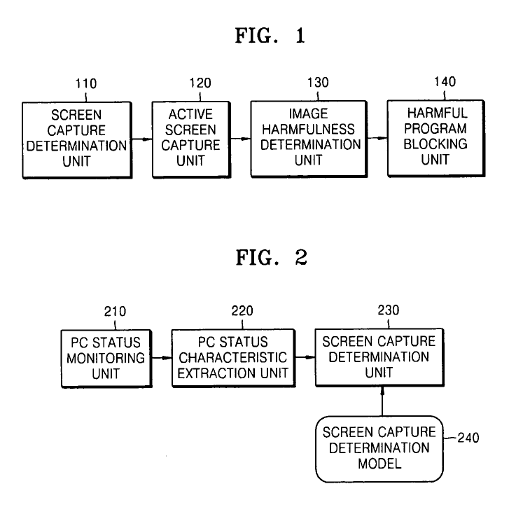

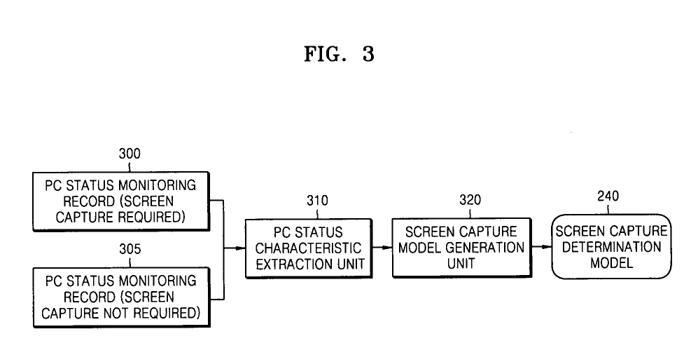

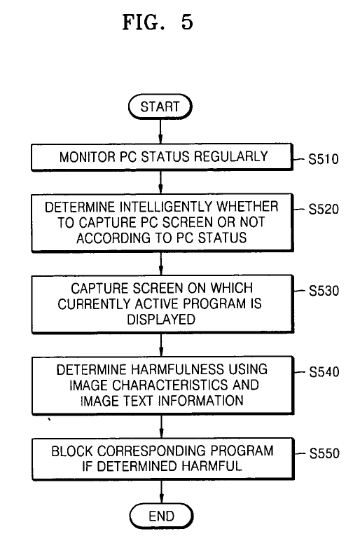

For the convenience of description, a method and apparatus according to embodiments of the present invention will be described together with reference to FIG. 5 illustrating a method of blocking harmful multimedia contents using intelligent screen monitoring according to an embodiment of the present invention. FIG. 1 is a block diagram of an apparatus for blocking harmful multimedia contents using intelligent screen monitoring in a personal computer (PC) according to an embodiment of the present invention. FIG. 2 is a block diagram illustrating a screen capture determination unit 110 illustrated in FIG. 1, and FIG. 3 is a detailed block diagram of the screen capture determination unit 110 illustrated in FIG. 2.

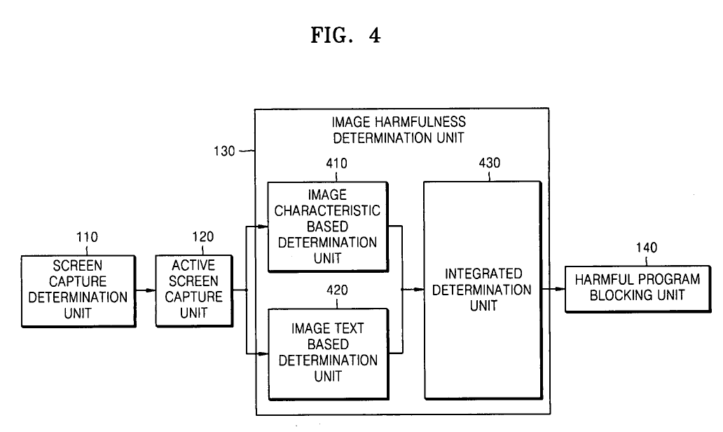

FIG. 4 is a block diagram of the apparatus for blocking harmful multimedia contents using intelligent screen monitoring in a PC of FIG. 1 with an image harmfulness determination unit 130 illustrated in detail. FIG. 5 is a flowchart of a method of blocking harmful multimedia contents using intelligent screen monitoring in a PC according to an embodiment of the present invention.

Referring to FIG. 1, the apparatus for blocking harmful multimedia contents according to the embodiment of the present invention includes the screen capture determination unit 110, an active screen capture unit 120, the image harmfulness determination unit 130, and a harmful program blocking unit 140. The screen capture determination unit 100 determines a time when a user might be attempting to access harmful multimedia contents while monitoring the status of a PC and decides whether to capture a screen in operation S510. While conventional methods capture the screen at regular intervals determined by a supervisor, in the method according to the present embodiment, the screen capture time is intelligently determined according to the result of monitoring the status of the PC in operation S520. Since, in the method of capturing screens at regular intervals predetermined by the supervisor, PC screens are captured at regular intervals regardless of the status of the PC, there are problems of frequent unnecessary capturing of screens and ease of evasion from being captured by displaying a screen having harmless contents at the capture time if a PC user knows the capture interval. However, since, in the apparatus and the method according to embodiments of the present invention, the screen capture time is determined intelligently, there is no waste of storage space caused by unnecessary screen captures, and conventional screen capture avoidance techniques are powerless since the screen is captured at irregular intervals according to the status of the PC.

If the screen capture determination unit 110 determines that the screen is to be captured, the active screen capture unit 120 captures the screen displaying the currently active program and transmits the captured screen to the image harmfulness determination unit 130. The image harmfulness determination unit 130 determines the harmfulness of the captured active screen using harmful image classification technology and text information extraction technology. If the image harmfulness decision unit 130 determines the screen to be harmful, the harmful program blocking unit 140 blocks the program displayed on the captured screen to prevent the user from accessing harmful multimedia contents in real time. While, in conventional methods, only log information of capturing the screen of the PC is recorded and the captured screen is stored in a storage space, the present invention blocks the program according to the harmfulness determination for the captured screen in real time using the harmful image processing technology and the text information extraction technology, thus making it possible to block harmful multimedia contents using the screen capture in real time.

The screen capture determination unit 110 illustrated in FIG. 1 will now be described in detail with reference to FIG. 2. Referring to FIG. 2, the screen capture determination unit 110 includes a PC status monitoring unit 210, a PC status characteristic extraction unit 220, a screen capture determination unit 230, and a screen capture determination model 240. The PC status monitoring unit 210 periodically extract PC status information including changes in the usage rates of a central processing unit, a memory, and a storage space, and the number of inputs from an input device, and transmits the status information to the PC status characteristic extraction unit 220 in operation S510. The PC status characteristic extraction unit 220 represents the status of the computer in the form of a characteristic vector represented by Equation 1 using the information transmitted from the PC status monitoring unit 210.
F=(ƒ₁,ƒ₂,ƒ₃, . . . ,ƒₙ) Equation 1

where F is characteristic vector describing the status of PC mathematically and having n elements. The screen capture determination unit 230 determines whether to capture the screen according to a determination value based on a screen capture model M dependent on the characteristic vector F according to Equation 2.
D=M(F) Equation 2

If D is greater than 0, the screen is captured, and if D is less than 0, the screen is not captured in operation S530.

FIG. 3 is a detailed block diagram of the screen capture determination unit 110. First, a PC status monitoring record 300 for when screen capture is required and a PC status monitoring record 305 for when screen capture is not required are distinguished and transmitted to the PC status characteristic extraction unit 310. The PC status characteristic extraction unit 310 transforms the PC status monitoring record 300 and 305 into the form of a vector according to Equation 1 and transmits the vector to the screen capture model generation unit 320. The screen capture model generation unit 320 generates the screen capture classification model 240 using a machine-learning algorithm and characteristic vectors extracted by the PC status characteristic extraction unit 310. The screen capture classification model 240 is represented by determination value, which is given by the following Equation 3.

$$D = {\sum }_{j = 1}^{k} {w}_{j} \cdot d ( {X}_{j} , F ) + {γ}_{j} , \qquad [ Equation 3 ]$$

wherein Wⱼ is a weighting factor, Xⱼ is a boundary vector distinguishing between when screen capture is required and screen capture is not require, d(Xⱼ,F) is the difference between the boundary vector Xⱼ and the characteristic vector F, and γⱼ is a compensation value. The screen capture classification model 240 is used by the screen capture determination unit 110 to determine whether to capture the screen.

The image harmfulness determination unit 130 illustrated in FIG. 1 will now be described in detail with reference to FIG. 4. Referring to FIG. 4, the image harmfulness determination unit 130 includes an image-characteristic-based determination unit 410, an image-text-based determination unit 420, and an integrated determination unit 430. The screen capture determination unit 110 determines when the screen is to be captured, the active screen capture unit 120 captures the screen displaying a currently active program and transmits the captured screen to the image harmfulness determination unit 130. The image-characteristic-based determination unit 410 included in the image harmfulness determination unit 130 extracts characteristics including a color, shape, and texture from an image and determines the harmfulness of the image using the extracted characteristics of the image and a learning-based harmful image classification method. The learning-based harmful image classification method is a method of generating a harmful image classification model capable of determining the harmfulness of an image using learning data classified in advance according to harmfulness and a machine learning algorithm and determining the harmfulness of the input image using the harmful image classification model.

When text-based harmful information is accessed through an Internet browser or a word processor, the harmfulness of the captured screen cannot be precisely determined by the image-characteristic-based determination unit 410. Thus, the image-text-based determination unit 420 is used together with the image-characteristic-based determination unit 410. The image text information is information obtained by extracting a text area included in the image and recognizing the extracted text area, and the image text based determination unit 410 determines the harmfulness of the recognized text using a method of comparing the recognized information based on the text information extraction technology with a harmful word database or a learning-based harmful text classification method.

When comparing the recognized information with the harmful word database, the harmfulness of text is determined in consideration of the correspondence between words in the extracted text area and words in the harmful word database, and the number of the extracted words included in the harmful word database. The learning-based harmful text classification method is a method of generating a harmful text classification model capable of determining the harmfulness of text using learning data classified in advance according to harmfulness and a machine learning algorithm, and using the harmful text classification model to determine the harmfulness of input text.

The integrated determining unit 430 determines the overall harmfulness of contents using the degree of harmfulness determined by the image characteristics based determination unit 410 and the image text based determination unit 420 and a weighted decision function of Equation 4.
H=α·A+β·B Equation 4
where A denotes the harmfulness of the captured screen as determined by the image-characteristic-based determination unit 410, and B denotes the harmfulness of the captured screen as determined by the image-text-based determination unit 420, and α and β are weight coefficients. The overall harmfulness H is calculated considering the harmfulness determined by the determination units 410 and 420 and the corresponding weight coefficients. When H is greater than a critical value defined by a supervisor, the contents are determined to be harmful; otherwise the contents are determined to be harmless in operation S540.

The harmful program blocking unit 140 blocks the program on the screen when the screen is determined to be displaying harmful information in operation S550.

The harmful multimedia contents blocking method according to the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), flash memory, CD-ROMs, magnetic tapes, hard disks, floppy disks, optical data storage devices, and carrier waves such as data transmission through the Internet. The computer readable recording medium can also be distributed over network coupled computer systems so that the computer readable code is stored and executed in a distributed fashion. The data structure of font ROM according to the present invention may be embodied as computer readable code on a computer readable recording medium such as ROM, RAM, magnetic tapes, hard disks, floppy disks, flash memory, and optical data storage devices.

As described above, in an apparatus and method for blocking harmful multimedia contents using intelligent screen monitoring according to the present invention, a PC screen is captured intelligently, the harmfulness of the captured screen is determined, and a corresponding program which is being displayed on the captured screen is blocked when the screen is determined to be harmful in order to block access to harmful multimedia contents in real time Since, in the apparatus and method according to the present invention, the screen is captured intelligently while monitoring the PC status instead at intervals determined by the supervisor, there is no waste of storage space caused by unnecessary screen captures, and conventional screen capture evasion technology, which works against a capture method performing a capture at regular intervals, does not work against the present invention.

In addition, since a corresponding process displayed on the captured screen is blocked according to the determination of harmfulness in real time, the apparatus and method can be used to block a user from accessing harmful information in real time, which is not possible with a conventional method of storing and recording the captured screen after capturing the screen, and can improve the accuracy of the harmfulness determination by considering text information included in the image together with image characteristics to determine the harmfulness.

Since the harmfulness is determined according to the captured screen, the apparatus and method according to the present invention don't have problems of reducing network speed, destabilization due to interference between a program implementing the method and other programs, and limited compatibility with specific programs, which occur in a apparatus using a method of analyzing data transmitted via networks to determine the harmfulness. Also, the method and apparatus according to the present invention are applicable to a variety of digital equipment including portable multimedia players like MP3 players and portable media players, mobile phones, and personal digital assistants.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A harmful multimedia contents blocking apparatus using intelligent screen monitoring comprising:
a screen capture determination unit determining a screen capture time based on the status of a personal computer;
an active screen capture unit capturing a screen displaying an active program at the screen capture time;
an image harmfulness determination unit determining the harmfulness of the captured screen; and
a harmful program blocking unit blocking the program displayed on the captured screen, if the screen is determined to be harmful.

2. The harmful multimedia contents blocking apparatus of claim 1, wherein the screen capture determination unit comprises:
a personal computer status monitoring unit extracting status information of the personal computer including changes in usage rates of a central processing unit, memory, and storage space and the number of inputs per hour from an input device;
a personal computer characteristic extraction unit generating a first characteristic vector based on the status information of the personal computer; and
a screen capture determination unit generating a predetermined screen capture model in which the first characteristic vector is a model variable, comparing the screen capture model with a predetermined reference value, and determining whether to capture the screen.

3. The harmful multimedia contents blocking apparatus of claim 2, wherein the screen capture determination unit comprises:
a screen capture modeling unit receiving a record of the personal computer status when the screen capture is required and a record of the personal computer status when the screen capture is not required, and generating a second characteristic vector; and
a screen capture determination modeling unit generating a screen capture classification model based on a predetermined machine-learning algorithm and the second characteristic vector.

4. The harmful multimedia contents blocking apparatus of claim 3, wherein the screen capture classification model is determined by D given by Equation 5
$$D = {\sum }_{j = 1}^{k} {w}_{j} \cdot d ( {X}_{j} , F ) + {γ}_{j} , \qquad [ Equation 5 ]$$
wherein Wⱼ is a weight, Xⱼ is a boundary vector distinguishing between when the screen is to be captured and when the screen is not to be captured, d(Xⱼ,F) is the difference between the boundary vector and the second characteristic vector, γⱼ is a compensation value, and the screen is captured if D is greater than 0.

5. The harmful multimedia contents blocking apparatus of claim 1, wherein the image harmfulness determination unit comprises:
an image-characteristic-based determination unit extracting image characteristics including color, shape, and texture from the captured screen and determining the harmfulness of the image;
a text-characteristic-based determination unit extracting a text area from the captured screen and determining the harmfulness of the text; and
an integrated determination unit determining the harmfulness of the captured screen based on the harmfulness of the image and the harmfulness of the text.

6. The harmful multimedia contents blocking apparatus of claim 5, wherein the integrated determination unit determines the screen to be harmful if an overall harmfulness, determined by summing harmfulness of image and text after applying a variable weight respectively, is greater than a critical value.

7. A harmful multimedia contents blocking method using intelligent screen monitoring, the method comprising:
(a) determining a screen capture time while monitoring the status of a personal computer;
(b) capturing a screen displaying a current active program on a personal computer at the screen capture time;
(c) determining the harmfulness of the captured screen; and (d) blocking the program displayed on the screen and storing related records, if the screen is determined to be harmful.

8. The harmful multimedia contents blocking method of claim 7, wherein step (a) comprises:
(a1) extracting status information from the personal computer including changes in usage rates of a central processing unit, a memory, and a storage space and the number of inputs per hour from an input device;
(a2) generating a first characteristic vector based on the status information of the personal computer; and
(a3) generating a predetermined screen capture model in which the first characteristic vector is a model variable, comparing the model with a predetermined reference value, and determining whether to capture the screen.

9. The harmful multimedia contents blocking method of claim 8, wherein step (a3) comprises:
(a31) receiving a record of the status of the personal computer when the screen capture is required and a record of the status of the personal computer when the screen capture is not required, and generating a second characteristic vector; and
(a32) generating a screen capture classification model based on a predetermined machine-learning algorithm and the second characteristic vector.

10. The harmful multimedia contents blocking method of claim 7, wherein step (c) comprises:
extracting image characteristics including color, shape, and texture from the captured screen and determining the harmfulness of the image;
extracting a text area from the captured screen and determining the harmfulness of the text; and
determining the screen to be harmful if an overall harmfulness, determined by summing harmfulness of image and text after applying a variable weight respectively, is greater than a critical value.
